(19) United States
(12) Patent Application Publication
(10) Pub. No.: US 2010/0189453 A1
(43) Pub. Date: Jul. 29, 2010

(54) IMAGE FORMING APPARATUS

(75) Inventor: Okito Ogasahara, Osaka-shi (JP)

Correspondence Address: HESPOS & PORCO LLP, 110 West 40th Street, Suite 2501, NEW YORK, NY, 10018, US

(73) Assignee: KYOCERA MITA CORPORATION, Osaka-shi (JP)

(21) Appl. No.: 12/691,911

(22) Filed: Jan. 22, 2010

(30) Foreign Application Priority Data
Jan. 27, 2009 (JP) 2009-015803

(51) Int. Cl. G03G 15/043

(52) U.S. Cl. 399/51

(57) ABSTRACT

A write reference signal generating unit uses horizontal synchronization signals output from BD sensors to generate, for each laser scanning unit of respective image forming units, a main scanning write reference signal for irradiating laser light from a semiconductor laser every other predetermined number of reflective surfaces when photosensitive drums are driven to rotate at a second speed of rotation which is slower than a standard speed of rotation. A phase adjustment unit adjusts the phase of a control signal for driving a polygonal mirror, which is output to a polygon motor of each image forming unit, on the basis of a relative time difference between image write timings of the respective laser scanning units as measured by a time difference measurement unit.

### BACKGROUND OF THE INVENTION

1. Field of the Invention

The present invention relates to a multi-beam type of image forming apparatus which carries out color image formation by irradiating respective laser lights emitted from a plurality of laser emitting units onto photosensitive bodies for respective colors, and more particularly, to technology for adjusting the write timing of the laser light scanned onto the photosensitive bodies for respective colors.

2. Description of the Related Art

In an image forming apparatus, such as a printer, when printing onto thick paper, OHP paper or creating prints of high luster, it is necessary to increase the amount of heat created by fixing compared to a case of normal image output, and therefore, in general, the necessary amount of heat for fixing is ensured by either raising the fixing temperature or extending the fixing time. However, if the fixing temperature is raised, then there are many problems, for instance, the fact that it takes time to stabilize the temperature, the increase in the power consumption, the need for thermal resistance countermeasures, and so on, and therefore, a means of extending the fixing time by lowering the speed of paper conveyance is often employed.

In this case, technology has been proposed whereby, during laser irradiation for exposure, without changing the rotational speed of a rotating polyhedron or the amount of laser light, the rotational speed of the rotating body and the conveyance speed of the paper are slowed and the time taken for the paper to pass through the fixing unit is lengthened, a surface of the rotating polyhedron being used once every certain number of times. In this method, the main scanning write reference signal output from a synchronizing sensor is counted, and laser light is irradiated in accordance with the main scanning write reference signal, every certain number of times. By this means, since the laser scanning speed and quantity of light are not altered, then even if the rotational speed of the rotating body and the conveyance speed of the paper are slowed, this has little effect on image quality.

However, if this method is adapted to a multi-beam method carried out using a plurality of laser lights respectively for forming images of respective colors, then since the scanning lines which are irradiated onto one reflective surface and are thereby scanned on the surface of the photosensitive body are equal to the number of laser lights in the sub-scanning direction, if image adjustment is carried out by means of the method described above, the image write timings are differentiated in units of the number of beams, and therefore it is not possible to correct for color deviation with high accuracy.

Therefore, as technology for ensuring highly accurate correction of color deviation in this case, technology has been proposed whereby a rotating polyhedron is provided for each of the laser scanning units of the respective colors, and the phase of the relative angle of rotation between the rotating polyhedrons of the respective laser scanning units is controlled.

### SUMMARY OF THE INVENTION

The present invention further improves upon the conventional technology described above.

In other words, the present invention comprises: a plurality of laser scanning units, each including: a photosensitive body; a plurality of laser light emitting units which emit laser light corresponding to an image signal; a rotating polyhedron having a plurality of reflective surfaces for scanning the laser light emitted from the respective laser light emitting units over the surface of the photosensitive body; and a synchronization sensor which receives laser light scanned by the rotating polyhedron and generates a horizontal synchronization signal for determining an image write timing; a rotating polyhedron drive control unit which controls the driving of the respective rotating polyhedrons; a photosensitive body drive control unit which drives the respective photosensitive bodies at a predetermined standard speed of rotation and a predetermined second speed of rotation which is slower than the standard speed of rotation; a write reference signal generating unit which uses the horizontal synchronization signals output from each synchronization sensor to generate, for each laser scanning unit, a main scanning write reference signal for irradiating the laser light onto all of the reflective surfaces of the rotating polyhedron when the photosensitive body is driven to rotate at the standard speed of rotation, and a main scanning write reference signal for irradiating the laser light onto every other number of reflective surfaces as determined in accordance with the second speed of rotation, when the photosensitive body is driven to rotate at the second speed of rotation; a time difference measurement unit which measures a relative time difference between image write timings of the respective laser scanning units, by using the main scanning write reference signals for each of the laser scanning units as generated by the write reference signal generating unit; and a phase adjustment unit which adjusts the phase of control signals for driving the rotating polyhedrons output by the rotating polyhedron drive control unit to the respective rotating polyhedrons, on the basis of the time difference measured by the time difference measurement unit.

### BRIEF DESCRIPTION OF THE DRAWINGS

FIG. 1 is a diagram showing the approximate composition of a printer relating to one embodiment of the present invention;

FIG. 2 is a perspective diagram showing laser beam scanning by a laser scanning unit shown in FIG. 1;

FIG. 3 is a block diagram showing the approximate composition of the control system of the printer;

FIG. 4 is a flowchart showing the process of phase adjusting the polygonal mirror rotational drive signal in accordance with the speed of rotation of the photosensitive drum in the printer; and

FIGS. 5A and 5B are diagrams showing one example of a main scanning write reference signal relating to a laser scanning unit in one image forming unit, and a main scanning write reference signal relating to a laser scanning unit in another image forming unit.

### DESCRIPTION OF THE PREFERRED EMBODIMENTS

Below, one embodiment of an image forming apparatus relating to the present invention is described on the basis of the drawings. Parts of the composition which are labeled with the same reference numerals in the drawings indicate the same composition, and description thereof is omitted here. The image forming apparatus relating to the present invention may be an image forming apparatus based on an electrophotographic system, such as a copying apparatus, printer apparatus, facsimile apparatus, or the like, and below a printer apparatus is described as an example.

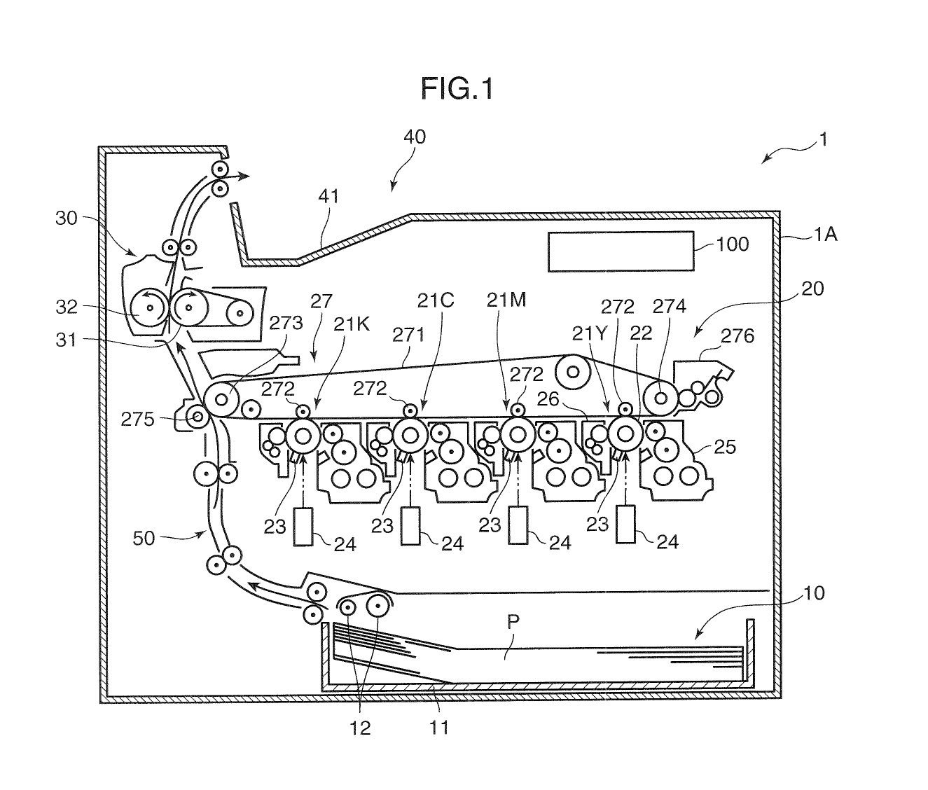

The printer which is one embodiment of an image forming apparatus will now be described. FIG. 1 is a diagram showing the approximate composition of a color printer relating to one embodiment of the present invention. In FIG. 1, the printer 1 comprises a paper storage unit 10, an image forming unit 20, a fixing unit 30, a paper output unit 40, a paper conveyance passage 50, and a control unit 100, and the paper storage unit 10, the image forming unit 20, the fixing unit 30, the paper conveyance passage 50 and the control unit 100 are installed inside a substantially box-shaped apparatus main body 1A, and the paper output unit 40 are provided in the top portion of the apparatus main body 1A.

The paper storage unit 10 stores paper P, which is one example of a transfer material supplied to the printing process, and the paper P is taken up and supplied under the control the control unit 100. In the paper storage unit 10, a prescribed number of paper cassettes 11 (in the present embodiment, one paper cassette) are provided detachably with respect to the apparatus main body 1A. A pick-up roller 12 which pays out paper P from the paper stack, one sheet at a time, is provided on the upstream end of the paper cassette 11 (to the upper left side of the paper cassette 11 in the example shown in FIG. 1). The paper P paid out from the paper cassette 11 by the driving of the pick-up roller 12 is supplied to the paper conveyance passage 50.

Under the control of the control unit 100, the image forming unit 20 carries out an image transfer process onto each separate sheet of paper P paid out from the paper stack stored in the paper storage unit 10, on the basis of an image signal received from a computer, or the like, but an interface circuit (not illustrated). The interface circuit is connected to an external device, such as a computer, via a LAN (Local Area Network), or the like, and sends and receives various signals to and from the external device; for instance, a network interface (10/100 Base-TX) or the like is used. The image forming unit 20 is constituted by image forming units 21Y, 21M, 21C and 21K for respective colors which form toner images, a transfer apparatus 27 which transfers the toner images formed by the image forming units 21Y, 21M, 21C and 21K, onto the paper P, and a fixing unit 30.

The image forming units 21Y, 21M, 21C and 21K are disposed in sequence in the following order: a yellow image forming unit 21Y, a magenta image forming unit 21M, a cyan image forming unit 21C and a black image forming unit 21K, in a substantially horizontal direction from the upstream side (the right-hand side of the drawing in FIG. 1) toward the downstream side. Moreover, the image forming unit 20 comprises a laser scanning unit 24 which is disposed in a position below the respective image forming units. The image forming units 21Y, 21M, 21C and 21K each have a similar composition, and are located and installed in a prescribed relative positional relationship with respect to the various devices inside the apparatus main body 1A.

These image forming units 21Y, 21M, 21C and 21K respectively comprise a photosensitive drum 22, a charger 23, a laser scanning unit 24, a developer apparatus 25 and a cleaning apparatus 26; the photosensitive drum 22 is provided rotatably about a drum axle which extends in the front/rear direction (the direction perpendicular to the plane of the drawing in FIG. 1), and the charger 23, the laser scanning unit 24, the developer apparatus 25 and the cleaning apparatus 26 are disposed following a counter-clockwise direction, which is the direction of rotation of the photosensitive drum 22, from a position directly below the photosensitive drum 22 so as to follow the circumferential surface of the photosensitive drum 22.

An electrostatic latent image and a toner image (visual image) corresponding to this electrostatic latent image are formed on the photosensitive drum 22. The charger 23 forms a uniform charge on the circumferential surface of the photosensitive drum 22 which is rotated in a counter-clockwise direction about the drum axle, and is constituted, for example, by a charging roller which applies charge to the photosensitive drum 22 while the circumferential surface thereof abuts against and rotates idly with the circumferential surface of the photosensitive drum 22. The developer apparatus 25 supplies toner to the circumferential surface of the photosensitive drum 22, thus causing toner to become attached to the portion of the circumferential surface where an electrostatic toner image has been formed, and thereby forms a toner image on the circumferential surface of the photosensitive drum 22.

In the present embodiment, in order to correspond to a color apparatus, yellow (Y) toner is accommodated in the developer apparatus 25 of the yellow image forming unit 21Y, magenta (M) toner is accommodated in the developer apparatus 25 of the magenta image forming unit 21M, cyan (C) toner is accommodated in the developer apparatus 25 of the cyan image forming unit 21C, and black (K) toner is accommodated in the developer apparatus 25 of the black image forming unit 21K. The developer apparatuses 25 are described in more detail below. The cleaning apparatuses 26 serve to clean the photosensitive drum 22 by removing toner remaining on the circumferential surface of the photosensitive drum 22 after the transfer process. The circumferential surface of the photosensitive drum 22 which has been cleaned by the cleaning apparatus 26 then comes to face the charger 23 again in order to perform the next image forming process.

The exposure apparatus 24 is a laser scanning unit which forms an electrostatic latent image on the circumferential surface of the photosensitive drum 22 by irradiating laser light having strong or weak intensity on the basis of the image data, onto the circumferential surface of the rotating photosensitive drum 22, between the charger 23 and the developer apparatus 25. Below, the exposure apparatus 24 is called a laser scanning unit 24. In order to correspond to a color image, laser scanning units 24 irradiate respective laser lights corresponding to the colors of yellow, magenta, cyan and black, onto the photosensitive drums 22 of the respective image forming units 21Y, 21M, 21C and 21K. When laser light is irradiated onto the circumferential surface of a charged photosensitive drum 22, the charge in the irradiated portion is erased in accordance with the intensity of the laser light, and by this means an electrostatic latent image is formed on the circumferential surface of the photosensitive drum 22. The image data is respective image data for the development colors of yellow, magenta, cyan and black, this image data being generated by taking an image signal from an external device, such as a computer, received via an interface circuit (not illustrated), and subjecting the image signal to commonly known color correction processing, or the like.

The transfer apparatus 27 is an apparatus for transferring a toner image formed on the circumferential surface of the photosensitive drum 22, to paper P, and the transfer apparatus 26 comprises an intermediate transfer belt 271, a primary transfer roller 272, a drive roller 273, an idle roller 274 and a secondary transfer roller 275. The intermediate transfer belt 271 is an endless belt, which is tensioned about the primary transfer roller 272, the drive roller 273 and the idle roller 274 at a position directly above the respective image forming units 21Y, 21M, 21C and 21K, and is rotatable in the clockwise direction by means of the rotational drive force of the drive roller 273. Primary transfer rollers 272 are provided respectively so as to correspond to the respective photosensitive drums 22 of the image forming units 21Y, 21M, 21C and 21K, being disposed so as to press against the intermediate transfer belt 271 and prevent the intermediate transfer belt 271 from floating up from the photosensitive drum 22. The secondary transfer roller 275 is disposed in a position opposing the drive roller 273 on the outer circumferential surface of the intermediate transfer belt 271.

The drive roller 273 is earthed. The primary transfer rollers 272 are supplied with a voltage of opposite polarity to the polarity of charge of the toner, as a primary transfer bias, while the toner image in the image region is primarily transferred from the photosensitive drum 22 to the intermediate transfer belt 271. Furthermore, the secondary transfer roller 275 is supplied with a voltage of opposite polarity to the polarity of charge of the toner, as a secondary transfer bias, while the toner image on the intermediate transfer belt 271 is secondarily transferred to the paper P. In this way, the printer 1 relating to the present embodiment employs an indirect transfer method.

An intermediate transfer belt cleaning apparatus 276 is provided on the right-hand side (in terms of the drawings) of the idle roller 274, toner remaining on the surface of the intermediate transfer belt 271 after transfer processing of the toner image onto the paper P is removed by the intermediate transfer belt cleaning apparatus 276, and the intermediate transfer belt 271 which has been cleaned in this way is then supplied to the photosensitive drum 22.

The fixing unit 30 carries out a fixing process by heating of the toner image on the paper P which has undergone the transfer process described above, under the control of the control unit 100, and comprises a heat roller 31 having an electric heating body installed therein, and a pressurizing roller 32 which is disposed in such a manner that the circumferential surface thereof opposes the circumferential surface of the heat roller 31. The paper P after transfer processing is subjected to a fixing process while receiving heat from the heat roller 31, by passing through a nip section between the heat roller 31 which is driven to rotate in the clockwise direction about the roller axis and the pressurizing roller 32 which rotates idly in the counter-clockwise direction about the roller axis. The paper P that has gone through the fixing process is output to a paper output section 40 via the paper conveyance passage 50.

The paper output section 40 accumulates paper P which has been output after undergoing the fixing process in the fixing unit 30. The paper output section 40 is formed by creating a depression in the top portion of the apparatus main body 1A, and a paper output tray 41 which receives paper P that has been output is formed in the bottom of the depressed recess portion thus formed.

The paper conveyance passage 50 conveys the paper P supplied from the paper storage unit 10, via the image forming unit 20 and the fixing unit 30, to the paper output unit 40, under the control of the control unit 100.

The control unit 100 is connected to the paper storage unit 10, the image forming unit 20, the fixing unit 30 and the paper conveyance passage 50, and the like, and by controlling these in accordance with their functions, the control unit 100 executes control of the respective units of the printer 1. The control unit 100 is, for example, constituted by a microcomputer comprising a CPU (Central Processing Unit), a ROM (Read Only Memory) which previously stores various programs that are executed by the CPU and data necessary for their execution, and the like, a RAM (Random Access Memory) which is a so-called working member of the CPU, and peripheral circuits, and the like.

To describe an image forming operation in a printer 1 having a composition of this kind, firstly, the photosensitive drum 22 is charged by the charger 23, whereupon exposure is performed by the laser scanning unit 24 and an electrostatic latent image is formed on the surface of the photosensitive drum 22. This electrostatic latent image is converted into a toner image by the developer apparatus 25, and this toner image formed on the surface of the photosensitive drum 22 is transferred onto the intermediate transfer belt 271 by the transfer bias applied to the primary transfer roller 272. Thereupon, the residual toner remaining on the photosensitive drum 22 which has not been transferred to the intermediate transfer belt 271 is cleaned by the cleaning apparatus 26 and collected into a recovery bottle (not illustrated). These operations of exposure, development and transfer are carried out in sequence for each of the development colors of yellow, magenta, cyan and black, thereby superimposing toner images of the respective colors on the surface of the intermediate transfer belt 271, and hence a full color toner image is formed on the intermediate transfer belt 271.

When a full color toner image has been formed on the intermediate transfer belt 271, the secondary transfer roller 275 abuts against the intermediate transfer belt 271 and the full color toner image formed on the intermediate transfer belt 271 is transferred, by the secondary transfer bias applied to the secondary transfer roller 275, to the paper P which has been conveyed with synchronized timing from the paper storage unit 10 to the paper conveyance passage 50. The full color toner image transferred to the paper P is fixed onto the paper P by the heating and pressurization actions of the fixing unit 30, and the paper P is then output to the paper output section 40. The toner remaining on the intermediate transfer belt 271 is cleaned by the intermediate transfer belt cleaning apparatus 276 of the intermediate transfer belt 271 abutting against the intermediate transfer belt 271 after secondary transfer, and this residual toner is collected into a recovery bottle (not illustrated).

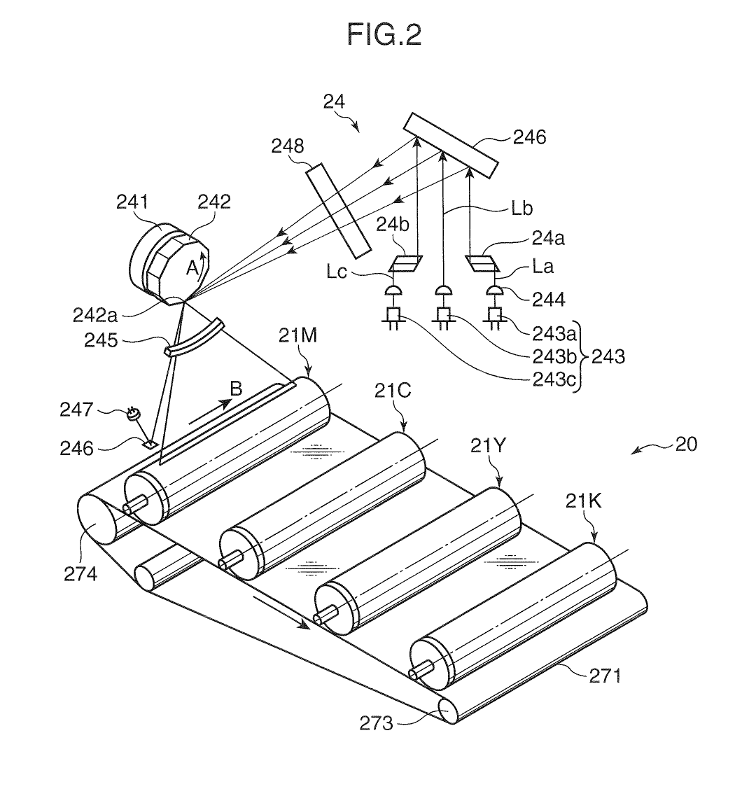

FIG. 2 is a perspective diagram showing laser beam scanning by a laser scanning unit 24 shown in FIG. 1. The laser scanning unit 24 consists of a laser beam scanning mechanism of a multi-beam type which scans a scanning line extending in a main scanning direction by means of a plurality of laser lights aligned in a sub-scanning direction. The laser scanning units 24 in the respective image forming units 21M, 21C, 21Y and 21K each have the same composition, and therefore the image forming unit 21M is described below as an example.

The laser scanning unit 24 comprises a polygon motor 241, a polygonal mirror 242, a semiconductor laser 243, a collimator lens 244, an f/θ lens 245, a reflecting mirror 246, a BD sensor 247, a cylindrical lens 248 and prisms 24a and 24b.

The polygonal mirror (rotating polyhedron) 242 has reflecting surfaces comprising a 10-sided mirror surface, for example, and reflects laser light toward the surface of the photosensitive drum 22 from each of the respective reflecting surfaces. The polygon motor 241 supplies drive force for rotating the polygonal mirror 242 in the direction of arrow A in FIG. 2, to the polygon motor 241. The semiconductor laser (laser emitting unit) 243 emits laser light, and is modulated on and off by a semiconductor laser drive control unit 1012, which is described below, in accordance with an input image signal. The semiconductor laser 243 is a three-beam laser system comprising three LDs 243a, 243b and 243c. The collimator lens 244 transmits the beams La, Lb, Lc emitted from the LDs 243a to 243c and converts the beams into parallel light. The light paths of the beams La and Lc are changed by the prisms 24a and 24b, and the beam Lb is directly incident on the reflecting mirror 246. It is also possible to dispose flat mirrors instead of the prisms 25a and 25b.

The beams La to Lc reflected by the reflecting mirror 246 are transmitted through the cylindrical lens 248, and are then focused as line images on the reflective surface 242a of the polygonal mirror 242. The reflecting mirror 246 and the cylindrical lens 248 adjust the angle of incidence of the beams La to Lc on the reflective surface 242a in such a manner that the beams La to Lc are converged and focused in a uniform region on the reflective surface 242a. The polygonal mirror 242 rotates at a uniform speed in the direction of arrow A in FIG. 2, and the beams La to Lc deflected by the reflective surface 242a are incident on the f/θ lens 245 while moving in the direction of arrow B in FIG. 2.

The f/θ lens 245 scans the laser light deflected by the polygonal mirror 242 horizontally at a uniform speed with respect to the axle direction of the photosensitive drum 22. The reflective mirror 246 guides the deflected laser light onto a beam detecting sensor (BD sensor, synchronization sensor) 247. The BD sensor 247 generates a horizontal synchronization signal which forms a write reference signal in the main scanning direction (horizontal direction) of the photosensitive drum 22.

The beams La to Lc which are transmitted by the f/θ lens 245 are focused as beam spots on the surface of the photosensitive drum 22, and image information is recorded by scanning light over the scanned surface of the photosensitive drum 22 in the main scanning direction and the sub-scanning direction by the rotation of the polygonal mirror 242 and the photosensitive drum 22. In this case, the beams La to Lc are incident at the same point when incident on the f/θ lens 245 and the beams La to Lc are mutually superimposed in the main scanning direction on the surface of the photosensitive drum 22, whereas the beams are split and incident respectively at different positions in the sub-scanning direction. Consequently, after being transmitted by the f/θ lens 245, the beams La to Lc are focused at a prescribed beam interval apart in the sub-scanning direction on the photosensitive drum 22 and three scanning lines aligned in the sub-scanning direction are scanned simultaneously. In other words, the laser scanning unit 24 scans three scanning lines arranged in the sub-scanning direction, each scanning line extending in the main scanning direction.

The laser scanning unit 24 changes the laser light irradiation method for performing light exposure in accordance with the speed of rotation of the photosensitive drum 22. In the present embodiment, in the printer 1, the photosensitive drum 22 is driven by the drum motor drive control unit 1013 described below so as to rotate at two different speeds: a predetermined standard speed of rotation (the speed of rotation when forming an image on normal printing paper), and a predetermined second speed of rotation which is slower than the standard speed of rotation (the speed of rotation when printing onto thick paper, OHP sheet, or special paper for high-gloss printing, or the like). In accordance with this, in the laser scanning unit 24, the write reference signal generating unit 103 described below uses the horizontal synchronization signal output from the BD sensor 247 to generate, for each of the respective laser scanning units 24 of the image forming units 21Y, 21M, 21C and 21K, (1) a main scanning write reference signal for irradiating laser light from the semiconductor laser 243 onto all of the reflective surfaces 242a of the polygonal mirror 242, when the photosensitive drum 22 is driven to rotate at the aforementioned standard speed of rotation, and (2) a main scanning write reference signal for irradiating laser light from the semiconductor laser 243 onto every other number of reflective surfaces 242a, as determined in accordance with the second speed of rotation, when the photosensitive drum 22 is driven to rotate at the second speed of rotation described above. By this means, when irradiating laser light for light exposure, the laser scanning unit 24 irradiates laser light from the semiconductor laser 243 onto all of the reflective surfaces 242a of the polygonal mirror 242, when the photosensitive drum 22 is driven to rotate at the standard speed of rotation, and even if the photosensitive drum 22 is driven to rotate at the second speed of rotation, it is possible to perform an exposure operation without change in the number of rotations of the polygonal mirror 242 or the quantity of laser light from the semiconductor laser 243, with respect to a case where the photosensitive drum 22 is driven to rotate at the standard speed of rotation, by using the reflective surfaces 242a of the polygonal mirror 242 once every certain number of surfaces.

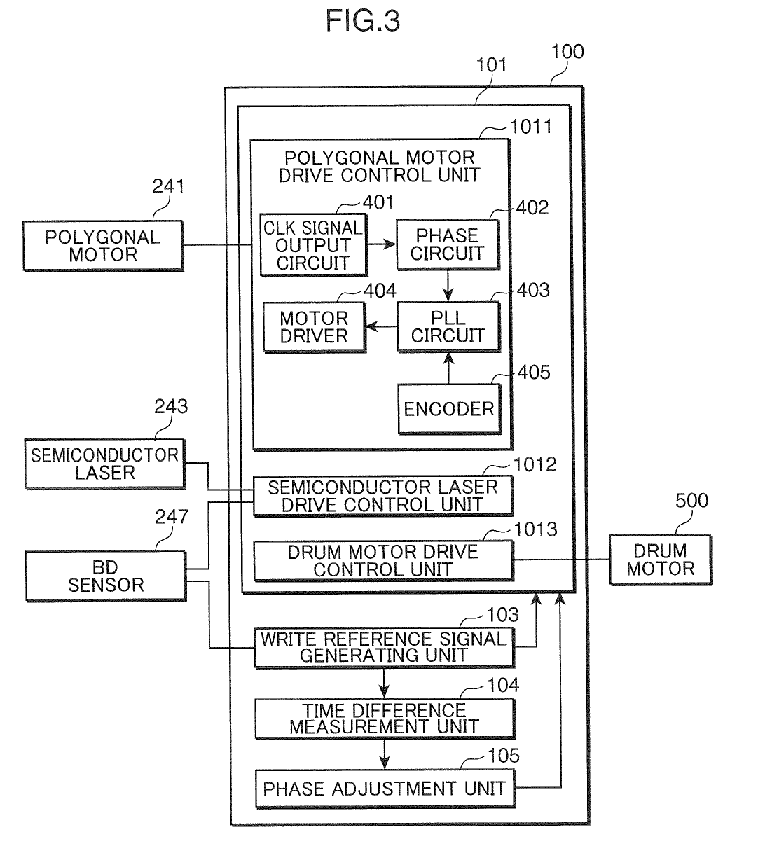

Next, the composition of the control system of the printer 1 will be described. FIG. 3 is a block diagram showing the approximate composition of the control system of the printer 1. The description given below centers principally on the composition relating to the present invention.

The printer 1 comprises a control unit 100. The control unit 100 executes overall operational control of the printer 1. The control unit 100 comprises an image formation control unit 101, a write reference signal generating unit 103, a time difference measurement unit 104 and a phase adjustment unit 105.

The image formation control unit 101 controls the driving of the respective units which operate during image formation. The image formation control unit 101 undertakes control of driving of the respective image forming units 21M, 21C, 21Y and 21K. The image formation control unit 101 comprises a polygonal mirror drive control unit 1011, a semiconductor laser drive control unit 1012, and a drum motor drive control unit 1013.

The polygonal motor drive control unit (rotational polyhedron drive control unit) 1011 drives the polygon motor 241 at a predetermined target speed of rotation on the basis of a clock signal (hereinafter, “CLK signal”) which is output from a block signal output circuit (hereinafter, “CLK signal output circuit”) 401. The polygon motor drive control unit 1011 comprises a CLK signal output circuit 401, a phase shift circuit 402, a PLL circuit (Pulse-Locked Loop: phase synch circuit) 403, a motor driver 404 and an encoder 405.

To describe the control of the speed of revolution of the polygon motor 241 by the polygon motor drive control unit 1011, upon receiving an image formation start request from an operator, the polygon motor drive control unit 1011 inputs a CLK signal output at a predetermined frequency from the CLK signal output circuit 401, to the PLL circuit (Pulse-Locked Loop: phase synchronization circuit) 403, via the phase shift circuit 402. The PLL circuit 403 compares the frequency of the input CLK signal with the rotational frequency of the polygon motor 241 output by an encoder 405 attached to the polygon motor 241 and outputs the resulting phase difference, the motor driver 404 supplies a drive current adjusted so as to cancel out this phase difference, to the polygon motor 241, the polygon motor 406 is driven to rotate in accordance with the drive current, and the speed of rotation of the motor (the number of revolutions of the motor per unit time) is made to converge to the target speed of rotation.

The semiconductor laser drive control unit 1012 is a driver which drives the semiconductor laser 243. When the speed of rotation of the polygon motor 241 has converged to the target speed of rotation, the semiconductor laser drive control unit 1012 reads the image data stored in the memory of the image reading unit 3, to an internally provided buffer, for several lines at a time, and the semiconductor laser 243 is driven and a bundle of light rays modulated on the basis of the image data are caused to be emitted from the semiconductor laser 243.

The drum motor drive control unit (photosensitive body drive control unit) 1013 controls the rotational driving of the drum motor 500 at two speeds during image formation: a predetermined standard speed of rotation (a speed of rotation when carrying out image formation onto normal printing paper), and a predetermined second speed of rotation which is slower than the standard speed of rotation (a speed of rotation when carrying out printing onto a thick paper, OHP sheet, special paper for high-luster printing, and the like).

The horizontal synchronization signal (BD signal) output from the BD sensor 247 is used as a synchronization signal for synchronizing the image write timing by the semiconductor laser 243 with the rotational operation of the polygonal mirror 242. The BD sensor 247 outputs a pulse wave as a horizontal synchronization signal when the BD sensors 247 has received a bundle of light rays of laser light reflected by the polygonal mirror 242.

Here, if the write timing of image data by the semiconductor laser 243 is not synchronized in the respective image forming units 21Y, 21M, 21C and 21K (in other words, if the image forming units 21Y, 21M, 21C and 21K are not in a state of writing image data in each main scanning direction scanning line by the semiconductor lasers 243 at write timings which are mutually separated by a predetermined uniform time difference), then color deviation occurs in the full color toner image formed by mutually superimposing the toner images. Therefore, the image formation control unit 101 synchronizes the image data write timings between the respective image forming units 21Y, 21M, 21C and 21K, before writing image data by means of the semiconductor lasers 243 in each of the image forming units 21Y, 21M, 21C and 21K (in other words, the image forming units 21Y, 21M, 21C and 21K are in a state of writing image data in each main scanning direction scanning line by the semiconductor lasers 243 at write timings which are mutually separated by a predetermined uniform time difference).

In accordance with this, the write reference signal generating unit 103 uses the horizontal synchronization signals (BD signals) output from the BD sensors 247 to generate, for each of the respective laser scanning units 24 provided in the image forming units 21Y, 21M, 21C and 21K, (1) a main scanning write reference signal for irradiating laser light from the semiconductor laser 243 onto all of the reflective surfaces 242a of the polygonal mirror 242, when the photosensitive drum 22 is driven to rotate at the aforementioned standard speed of rotation, and (2) a main scanning write reference signal for irradiating laser light from the semiconductor laser 243 onto every other number of reflective surfaces 242a, as determined in accordance with the second speed of rotation, when the photosensitive drum 22 is driven to rotate at the second speed of rotation described above.

The time difference measurement unit 104 measures the relative time difference between the image write timings of the respective laser scanning units 24, on the basis of the main scanning write reference signals in (1) and (2) above which are generated by the write reference signal generating unit 103 in respect of each of the laser scanning units 24 of the image forming units 21Y, 21M, 21C and 21K, when the photosensitive drum 22 is driven to rotate at the standard speed or rotation or the second speed of rotation.

The phase adjustment unit 105 adjusts the phase of the control signal for driving the polygonal mirror which is output by the polygon motor drive control unit 1011 to the polygon motor 241 of each image forming unit 21Y, 21M, 21C and 21K, on the basis of the time difference measured by the time difference measurement unit 104 (Details given later).

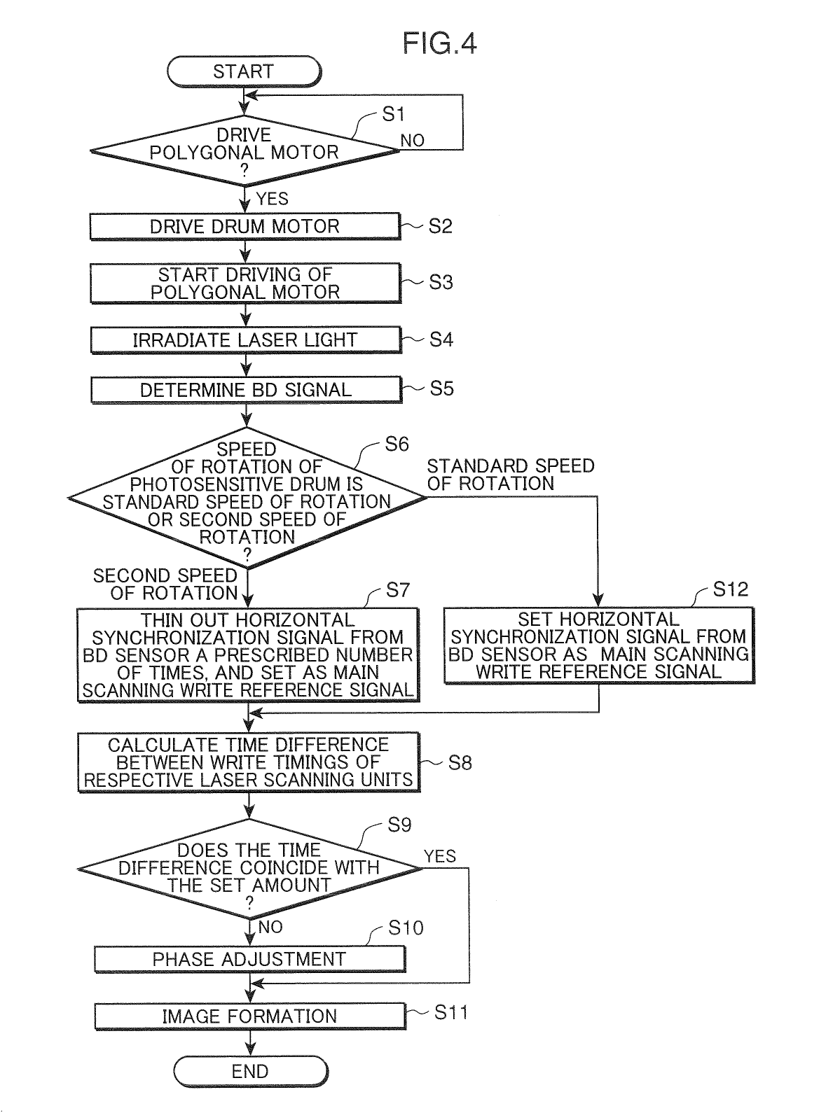

Next, the process of phase adjusting the polygonal mirror rotational drive signal in accordance with the speed of rotation of the photosensitive drum 22 in the printer 1 will be described. FIG. 4 is a flowchart showing the process of phase adjusting the polygonal mirror rotational drive signal in accordance with the speed of rotation of the photosensitive drum 22 in the printer 1.

Firstly, the image formation control unit 101 judges whether or not it is necessary to drive the polygon motor 241 (S1). More specifically, the image formation control unit 101 judges that driving of the polygon motor 241 is necessary if the printer apparatus is in a state such as power start up, returning from a standby mode (power saving standby state) to a normal operational mode (a state where a normal image formation operation is possible), or when an image formation execution request, such as a copying operation, has been made, or the like. Here, if the image formation control unit 101 has judged that driving of the polygonal mirror 242 is not necessary (NO at S1), then the process waits at step S1.

On the other hand, if the image formation control unit 101 judges that driving of the polygonal mirror 242 is necessary (YES at S1), then if the type of paper specified in accordance with a specification instruction for the paper to be used in image formation as input by the operator is, for example, a thick paper as described above, or the like, then the drum motor drive control unit 1013 controls the driving of the drum motor 500 so as to rotate the photosensitive drum 22 at the aforementioned second speed of rotation, whereas if the specified paper is a normal paper other than the thick paper described above, for example, the drum motor drive control unit 1013 controls the driving of the drum motor 500 so as to rotate the photosensitive drum 22 at the aforementioned standard speed of rotation (S2). Moreover, the polygon motor drive control unit 1011 drives the polygon motor 241 at a predetermined frequency of rotation of the polygon motor 241 (S3). In the present embodiment, the speed of rotation of the polygon motor 241 which is controlled and driven at the aforementioned frequency by the polygon motor drive control unit 1011 is uniform, irrespective of the speed of rotation of the photosensitive drum 22.

The semiconductor laser drive control unit 1012 drives the respective semiconductor lasers 243 of the image forming units 21Y, 21M, 21C and 21K and irradiates laser light onto the surface of the photosensitive drum 22 by means of the polygonal mirror 242, and the like (S4). In this case, the semiconductor laser drive control unit 1012 carries out irradiation of laser light by the semiconductor laser 243 onto all of the surfaces of the polygonal mirror 242. The write reference signal generating unit 103 detects the horizontal synchronization signal (BD signal) output from the BD sensor 247, due to this irradiation of laser light (S5).

Thereupon, the image formation control unit 101 judges whether the photosensitive drum 22 is to be rotated at the standard speed of rotation or at the second speed of rotation, by the drum motor drive control unit 1013 (S6). Here, if the image formation control unit 101 has judged that the speed of rotation of the photosensitive drum 22 is to be the standard speed of rotation (“standard speed of rotation” at S6), then the write reference signal generating unit 103 uses the horizontal synchronization signal detected in S5 above to generate a main scanning write reference signal for irradiating laser light from the semiconductor laser 243 onto all of the reflective surfaces 242a of the polygonal mirror 242 (S12). In other words, the write reference signal generating unit 103 outputs the respective horizontal synchronization signals output from the BD sensors 247 of the respective image forming units 21Y, 21M, 21C and 21K to the image formation control unit 101 and the time difference measurement unit 104, as main scanning write reference signals for the respective image forming units 21Y, 21M, 21C and 21K in order to irradiate laser light from the semiconductor lasers 243 onto all of the reflective surfaces of the polygonal mirror 242.

On the other hand, if the image formation control unit 101 has judged that the photosensitive drum 22 is to be rotated at the aforementioned second speed of rotation (“second speed of rotation” at S6), then the write reference signal generating unit 103 uses the horizontal synchronization signals detected at S5 above to generate main scanning write reference signals which cause laser light from the semiconductor lasers 243 to be irradiated onto the reflective surfaces 242a and reflected, every other number of reflective surfaces 242a, as determined in accordance with the second speed of rotation (S7). More specifically, the write reference signal generating unit 103 thins out each of the horizontal synchronization signals output from the BD sensors 247, according to the number of reflective surfaces 242a onto which laser light from the semiconductor laser 243 is not to be irradiated, and leaves only a horizontal synchronization signal corresponding to the reflective surfaces 242a onto which laser light is to be irradiated, this horizontal synchronization signal being output to the image formation control unit 101 and the time difference measurement unit 104 as a main scanning write reference signal corresponding to the second speed of rotation.

The time difference measurement unit 104 receives and detects the respective main scanning write reference signals of the image forming units 21Y, 21M, 21C and 21K which are generated by the write reference signal generating unit 103 in step S7 or S12 described above, and calculates the time difference in the image write timings between the laser scanning units 24 of the image forming units 21Y, 21M, 21C and 21K, on the basis of the main scanning write reference signals thus detected (S8). More specifically, the amount of deviation in rotational phase between the polygonal mirrors 242 of the laser scanning units 24 of the respective image forming units 21Y, 21M, 21C and 21K is determined by the time difference measurement unit 104.

The phase adjustment unit 105 judges whether or not the time difference t calculated at S8 coincides with a time difference ta that corresponds to a predetermined uniform amount of deviation in the rotational phase (if the difference between the two values is within a tolerable range, then the values are judged to “coincide”) (S9).

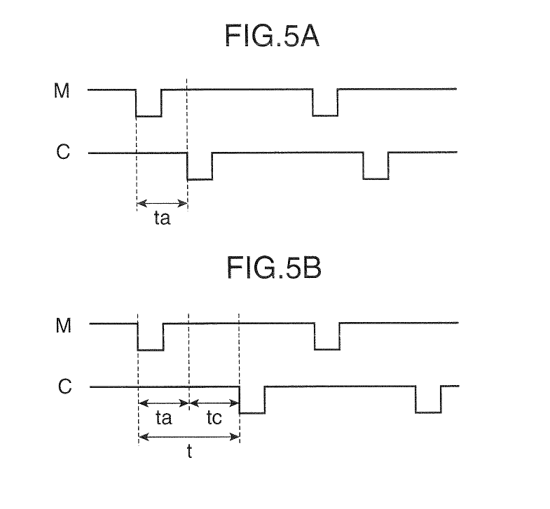

FIGS. 5A and 5B show examples of a main scanning write reference signal M which is input to the time difference measurement unit 104 from the BD sensor 247 of the laser scanning unit 24 of the image forming unit 21M, and a main scanning write reference signal C which is input to the time difference measurement unit 104 from the BD sensor 247 of the laser scanning unit 24 of the image forming unit 21C, in a case where the photosensitive drum 22 is driven to rotate at the standard speed of rotation. FIG. 5A shows a state where the time difference between the main scanning write reference signal M and the main scanning write reference signal C determined by the time difference measurement unit 104 is a time difference ta corresponding to a predetermined uniform amount of deviation in the rotational phase, and FIG. 5B shows a state where the time difference t between the scanning write reference signal M and the main scanning write reference signal C is a time difference t which is greater than the time difference ta.

The time difference measurement unit 104 measures the interval (time difference t) between the scanning write reference signal M and the main scanning write reference signal C, by taking the laser scanning unit 24 of a predetermined image forming unit of the respective image forming units 21Y, 21M, 21C and 21K as a reference (here, the laser scanning unit 24 of the image forming unit 21M is taken as a reference). If the time difference t is the time difference ta, then the phase adjustment unit 105 judges whether the amount of deviation in the rotational phase between the polygonal mirrors 242 of the image forming unit 21M and the image forming unit 21C coincides with a predetermined uniform amount. On the other hand, as shown in FIG. 5B, if the interval between the scanning write reference signal M and the main scanning write reference signal C is different to the time difference ta, as in the case of the time difference t, then the phase adjustment unit 105 judges that the amount of deviation in rotational phase between the polygonal mirrors 242 of the image forming unit 21M and the image forming unit 21C does not coincide with the predetermined uniform amount.

The judgment of whether or not the time difference measurement and the amount of deviation in the rotational phase relating to the other image forming units 21Y and 21K coincide with those of a reference image forming unit (the image forming unit 21M) is carried out similarly to the case of the image forming unit 21C with respect to the reference image forming unit (image forming unit 21M) which was described above.

Furthermore, the amounts of deviation in the rotational phase corresponding to the time difference ta or the time difference t can be determined readily by previously storing, in a ROM inside the phase adjustment unit 105, or the like, the relationship between the time difference ta or time difference t and the amounts of deviation in the rotational phase corresponding to these.

In step S9, if the phase adjustment unit 105 judges that the time difference t does not coincide with the time difference ta (NO at S9), then the phase adjustment unit 105 adjusts the phase of the control signal of the polygon motor 241 for driving the polygonal mirror in those image forming units where the time difference t does not coincide with the time difference ta, with respect to the main scanning write reference signal of the reference image forming unit, in such a manner that the time difference t becomes the time difference ta, and in this way the time difference t is made to coincide with the time difference ta (S10).

For example, as shown in FIG. 5B, if a time difference tc, which is the deviation between the time difference ta and the time difference t, occurs in the polygonal mirror 242 of the image forming unit 21C with respect to the polygonal mirror 242 of the image forming unit 21M which is the reference unit, then the phase adjustment unit 105 carries out a calculation for calculating the amount of correction required in order that the image forming unit 21C has a rotational phase deviation with respect to the reference image forming unit 21M that is equal to the time difference ta. For example, this calculation is made on the basis of correction information indicating the relationship between the amount of deviation in the rotational phase between the polygonal mirror 242 of the image forming unit 21C and the polygonal mirror 242 of the image forming unit 21M which is a reference (the amount of deviation of the time difference in the main scanning write reference signals described above), and the respective correction amounts of the rotational frequencies of the polygon motor 241 of the image forming unit 21C and the polygon motor 241 of the image forming unit 21M which is a reference unit. This correction information is stored previously in a ROM, or the like, inside the phase adjustment unit 105. Apart from this, for the phase adjustment, it is also possible to employ various other commonly known control methods.

In S9, the deviation of the rotational phase is adjusted so as to become the time difference to described above, and when the rotational phase control process has been completed, normal image formation (printing) is carried out by the image formation control unit 101 (S11). The judgment of whether or not the rotational phase control process has been completed is made by the phase alignment unit 105 on the basis of the main scanning direction write reference signals output from the BD sensors 247 of the respective image forming units 21Y, 21M, 21C and 21K.

According to this, the rotational phase adjustment of the polygonal mirrors 242 of the image forming units 21Y, 21M, 21C and 21K is carried out on the basis of the main scanning write reference signals generated by the write reference signal generating unit 103 for irradiating laser light from the semiconductor laser 243 onto every other number of reflective surfaces 242a, as predetermined in accordance with the second speed of rotation, in cases where the photosensitive body is driven to rotate at a second speed of rotation which is slower than the standard speed of rotation, and therefore it is possible to reduce the occurrence of problems which are observed with conventional technology, for example, the phase of the main scanning write reference signals of the respective laser scanning units being adjusted on the basis of a time difference calculated on the basis of a main scanning write reference signal, which ought to be ignored and does not form a trigger for irradiation of laser light, and the occurrence of color deviations when the respective color images are superimposed on each other.

The present invention is not limited to the composition of the embodiment described above and various modifications are possible. The composition and processes illustrated FIG. 1 to FIG. 5 above merely show one embodiment of the present invention, and the image forming apparatus relating to the present invention is not limited to the stated composition and processes.

In summary, the present invention is an image forming apparatus, comprising: a plurality of laser scanning units, each including: a photosensitive body; a plurality of laser light emitting units which emit laser light corresponding to an image signal; a rotating polyhedron having a plurality of reflective surfaces for scanning the laser light emitted from the respective laser light emitting units over the surface of the photosensitive body; and a synchronization sensor which receives laser light scanned by the rotating polyhedron and generates a horizontal synchronization signal for determining an image write timing; a rotating polyhedron drive control unit which controls the driving of the respective rotating polyhedrons; a photosensitive body drive control unit which drives the respective photosensitive bodies at a predetermined standard speed of rotation and a predetermined second speed of rotation which is slower than the standard speed of rotation; a write reference signal generating unit which uses the horizontal synchronization signals output from each synchronization sensor to generate, for each laser scanning unit, a main scanning write reference signal for irradiating the laser light onto all of the reflective surfaces of the rotating polyhedron when the photosensitive body is driven to rotate at the standard speed of rotation, and a main scanning write reference signal for irradiating the laser light onto every other number of reflective surfaces as determined in accordance with the second speed of rotation, when the photosensitive body is driven to rotate at the second speed of rotation; a time difference measurement unit which measures a relative time difference between image write timings of the respective laser scanning units, by using the main scanning write reference signals for each of the laser scanning units as generated by the write reference signal generating unit; and a phase adjustment unit which adjusts the phase of control signals for driving the rotating polyhedrons output by the rotating polyhedron drive control unit to the respective rotating polyhedrons, on the basis of the time difference measured by the time difference measurement unit.

According to this invention, when the rotating bodies are driven to rotate at a second speed of rotation which is slower than the standard speed of rotation, the write reference signal generating unit generates a main scanning write reference signal for irradiating laser light every other number of reflective surfaces, as determined in accordance with the second speed of rotation, in each of the laser emitting units of the laser scanning units, and the time difference measurement unit uses the main scanning write reference signals generated for each of the laser scanning units to measure the relative time difference between the image write timings in each of the laser scanning units. Therefore, when the phase adjustment unit adjusts the phase of the control signal for driving the rotating polyhedrons, it is possible to reduce the occurrence of problems observed with conventional technology, for example, the phase of the main scanning write reference signals of the respective laser scanning units being adjusted on the basis of a time difference calculated on the basis of a main scanning write reference signal that ought to be ignored and that does not form a trigger for irradiation of laser light, or the occurrence of color deviation when the respective color images are mutually superimposed.

In other words, when both of the inventions stated in the background art are combined, control is implemented for first irradiating laser light in accordance with a main scanning write reference signal, then ignoring the main scanning write reference signal output immediately thereafter for a certain number of times, and then irradiating laser light in accordance with the main scanning write reference signal after ignoring this certain number of times, while the phase of the angle of rotation of the rotating polyhedrons of the respective laser scanning units is controlled on the basis of the relative time difference in the main scanning write reference signals of the laser scanning units of each color. However, when controlling the phase in this way, the relative time difference between the main scanning write reference signals of the laser scanning units of the respective colors is calculated on the basis of a main scanning write reference signal that does not cause irradiation of laser light (a main scanning write reference signal that ought to be ignored), and if the phase of the angle of rotation of the rotating polyhedrons of the respective laser scanning units is controlled on the basis of this time difference, then color deviation occurs when the images formed by the image forming units of the respective colors are mutually superimposed.

In order to avoid this, it is necessary to employ a circuit which, in addition to managing a plurality of set values of the phase difference between the laser scanning units, also distinguishes accurately between a main scanning write reference signal which causes laser light to be irradiated and a main scanning write reference signal which does not cause laser light to be irradiated, in respect of the laser scanning units of each color, as well as using the main scanning write reference signals that cause laser light to be irradiated, as distinguished in this manner, to determine the phase difference between the angles of rotation of the rotating polyhedrons in the laser scanning units of the respective colors (in other words, to calculate the relative time differences between the main scanning write reference signals of the laser scanning units of the respective colors).

However, according to the present invention, in a multi-beam type of image forming apparatus, even in cases where the paper conveyance speed is changed in accordance with the type of paper used for image formation, it is possible to correct color deviation with good accuracy by performing accurate phase adjustment of the angles of rotation of the rotating polyhedrons, without requiring special circuitry and while cutting costs.

Furthermore, in the present invention, the write reference signal generating unit sets the horizontal synchronization signal output from each of the synchronization sensors as a main scanning write reference signal for irradiating the laser light onto all of the reflective surfaces of the rotating polyhedron when the photosensitive body is driven to rotate at the standard speed of rotation, and generates a main scanning write reference signal corresponding to the second speed of rotation by thinning out the horizontal synchronization signal output from each of the synchronization sensors, by the number of reflective surfaces not to be irradiated with the laser light when the photosensitive body is driven to rotate at the second speed of rotation.

According to the present invention, when the rotating bodies are driven to rotate at a standard speed of rotation, the write reference signal generating unit uses the horizontal synchronization signals themselves as main scanning write reference signals corresponding to the standard speed of rotation, whereas when the rotating bodies are driven to rotate at the second speed of rotation, the write reference signal generating unit thins out the horizontal synchronization signals in accordance with the number of reflective surfaces not to be irradiated with the laser light, and the thinned horizontal synchronization signals are taken as main scanning write reference signals corresponding to the second speed of rotation. Therefore, it is possible to generate main scanning write reference signals corresponding to both a standard speed of rotation and a second speed of rotation, by means of a relatively simple process.

Furthermore, in the present invention, the time difference measurement unit measures the relative time difference between the image write timings of the respective laser scanning units, by taking, as a reference, the main scanning write reference signal generated by a predetermined laser scanning unit, of the plurality of laser scanning units.

According to the present invention, since the time difference measurement unit measures the relative time difference between the image write timings of the respective laser scanning units with reference to the main scanning write reference signal generated by a predetermined laser scanning unit, of the plurality of laser scanning units, then this measurement of the time difference can be carried out without having to store a special reference signal for time difference measurement.

Furthermore, in the present invention, the photosensitive body drive control unit judges whether to drive the respective photosensitive bodies at either the standard speed of rotation or the predetermined second speed of rotation which is slower than the standard speed of rotation, in accordance with an instruction input from an operator and specifying the type of paper used for image formation.

This application is based on Japanese Patent Application Serial No. 2009-015803, filed in Japan Patent Office on Jan. 27, 2009, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming apparatus, comprising:
a plurality of laser scanning units, each including: a photosensitive body; a plurality of laser light emitting units which emit laser light corresponding to an image signal; a rotating polyhedron having a plurality of reflective surfaces for scanning the laser light emitted from the respective laser light emitting units over the surface of the photosensitive body; and a synchronization sensor which receives laser light scanned by the rotating polyhedron and generates a horizontal synchronization signal for determining an image write timing;
a rotating polyhedron drive control unit which controls the driving of the respective rotating polyhedrons;
a photosensitive body drive control unit which drives the respective photosensitive bodies at a predetermined standard speed of rotation and a predetermined second speed of rotation which is slower than the standard speed of rotation;
a write reference signal generating unit which uses the horizontal synchronization signals output from each synchronization sensor to generate, for each laser scanning unit, a main scanning write reference signal for irradiating the laser light onto all of the reflective surfaces of the rotating polyhedron when the photosensitive body is driven to rotate at the standard speed of rotation, and a main scanning write reference signal for irradiating the laser light onto every other number of reflective surfaces as determined in accordance with the second speed of rotation, when the photosensitive body is driven to rotate at the second speed of rotation;
a time difference measurement unit which measures a relative time difference between image write timings of the respective laser scanning units, by using the main scanning write reference signals for each of the laser scanning units as generated by the write reference signal generating unit; and
a phase adjustment unit which adjusts the phase of control signals for driving the rotating polyhedrons output by the rotating polyhedron drive control unit to the respective rotating polyhedrons, on the basis of the time difference measured by the time difference measurement unit.

2. The image forming apparatus according to claim 1, wherein the write reference signal generating unit sets the horizontal synchronization signal output from each of the synchronization sensors as a main scanning write reference signal for irradiating the laser light onto all of the reflective surfaces of the rotating polyhedron when the photosensitive body is driven to rotate at the standard speed of rotation, and generates a main scanning write reference signal corresponding to the second speed of rotation by thinning out the horizontal synchronization signal output from each of the synchronization sensors, by the number of reflective surfaces not to be irradiated with the laser light when the photosensitive body is driven to rotate at the second speed of rotation.

3. The image forming apparatus according to claim 1, wherein the time difference measurement unit measures the relative time difference between the image write timings of the respective laser scanning units, by taking, as a reference, the main scanning write reference signal generated by a predetermined laser scanning unit, of the plurality of laser scanning units.

4. The image forming apparatus according to claim 1, wherein the photosensitive body drive control unit judges whether to drive the respective photosensitive bodies at either the standard speed of rotation or the predetermined second speed of rotation which is slower than the standard speed of rotation, in accordance with an instruction input from an operator and specifying the type of paper used for image formation.
